(19) United States
(12) Patent Application Publication
(10) Pub. No.: US 2007/0290629 A1
(43) Pub. Date: Dec. 20, 2007

(54) MODULAR ILLUMINATION SYSTEM

(76) Inventor: Pinhas Paul Koren, Altamonte Springs, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/764,792

(22) Filed: Jun. 18, 2007

Related U.S. Application Data
(60) Provisional application No. 60/804,974, filed on Jun. 16, 2006.

(51) Int. Cl. H05B 41/36

(52) U.S. Cl. 315/291

(57) ABSTRACT

A modular light system, the system including a distribution panel, a light emitter connected to an output end of the distribution panel, a controller connected to an input end of the distribution panel, a power source connected to said controller, and a harden cap configured to fit around an illumination part of the light emitter at a first end and emits light from a second end that is decreased in diameter when compared to the first end.

### CROSS-REFERENCE TO RELATED APPLICATION

This application claims priority based on U.S. Provisional Application No. 60/804,974 filed Jun. 16, 2006.

### FIELD OF INVENTION

The field of invention relates to light emitting diode (LED) technology, and more particularly to a modular LED lighting assembly generally used as decorative illumination in and/or around residences and businesses.

### BACKGROUND OF THE INVENTION

LED lighting systems are becoming more used for illuminating signs and providing decorative illumination in and/or around residences and businesses. In most circumstances where such lighting systems are used, the light, or light emission device, and wire are permanently affixed to each other. If either the wire or light fails individually, both must be replaced. If a light, or light emission device, is detached, such as by cutting it, from a wire connecting it to a power source and/or light source, to simply replace the light emission device, not enough wire is typically available to connect the new light emission device to the existing wire because of the precise cut length of the wire. Furthermore, because of the limited access space that may be provided in its application, replacing a defective wire can be expensive and time consuming.

Additionally, many light systems are limited to a single controller that has a single LED that may then provide light to a plurality of fiber optic strands. Under such an approach if a controller fails, the complete system, all strands and/or LEDs illuminated by the controller are not able to function. Furthermore, because fiber optic strands are flexible, depending on conditions that may be experienced by the strands when used in a lighting application, the strands may break or become dislodged.

In view of the cost and time that results in having to fix a light system, or a LED within a system not emitting, owners of LED light systems would benefit from a system which would minimize the repair time and cost involved. Furthermore, when LED light systems are used in situations where movement of the systems may damage fiber optics that may be used, the owners would benefit from a lighting system that is able to withstand environmental changes. Furthermore, because of the cost to use many controllers, owners would also benefit from a system that minimizes the number of controllers used.

### SUMMARY OF THE INVENTION

A modular LED lighting assembly generally used as decorative illumination in and/or around residences and businesses is disclosed. A modular light system is disclosed having a distribution panel and a light emitter connected to an output end of the distribution panel. A controller connected to an input end of the distribution panel and a power source connected to the controller are also provided. A harden cap configured to fit around an illumination part of the light emitter at a first end and emits light from a second end that is decreased in diameter when compared to the first end is further disclosed.

A light emitter lens for use within a light emitting system, configured to experience high impact environments is further disclosed. The lens has a harden lens with a diameter proximate a size of a light emitter at a first end and a diameter significantly smaller at a second end.

In another exemplary embodiment, a distribution panel system for having a plurality of light emitters operated by a single controller is disclosed. The system has a distribution panel configured to receive a signal from a controller and distribute the signal to a plurality of light emitters. A releaseable connector attached to each cable the attaches to the distribution panel so that each device may be removed should a failure is determined to be caused by a respective device is also provided.

### BRIEF DESCRIPTION OF THE DRAWINGS

The invention itself, both as to organization and method of operation, may best be understood by reference to the following description in conjunction with the accompanying drawings in which like numbers represent like parts throughout the drawings and in which:

FIG. 1 depicts an exemplary illustration of a front side of a controller with elements that may be connected to the controller;

FIG. 2 depicts an exemplary illustration of a back side of the controller with elements that may be attached to the controller;

FIG. 3 depicts an exemplary illustration of a distribution panel with LED's attached;

FIG. 4A-4C depict a plurality of hardened light emitters that may provide light through a smaller diameter than the diameter of the LED; and

FIG. 5 depicts an illustration of caps fixed within a panel.

### DETAILED DESCRIPTION OF THE INVENTION

With reference to the figures, exemplary embodiments of the invention will now be described. The scope of the embodiments disclosed is applicable to a plurality of uses. Thus, even though embodiments are described specifically to decorative lighting for residences and businesses, the embodiments are also applicable for other uses or applications where wiring for a light system is run around a hard-to-reach-location, and an opening for the resulting light emitted is smaller than the light emitter, specifically the LED.

By residential and business uses, this may include but is not limited to architectural lighting such as interior and exterior lighting of residential homes, office complexes and/or other buildings. Similarly, the same or other embodiments may be used in landscaping, such as illuminating sidewalks, pools of water, waterfalls or any other area that needs to be illuminated, including underwater applications.

Furthermore, though the present invention is disclosed specific to LED lights, other forms of lights, such as fiber optic lighting, nano-tubes, surface mounted lasers, solid state lasers, semiconductor lasers and electro-luminescent diodes and/or tapes, are also applicable. Those skilled in the art will readily recognize that a plurality of ways is available to implement embodiments depending on the lighting source used and/or the purpose of the light.

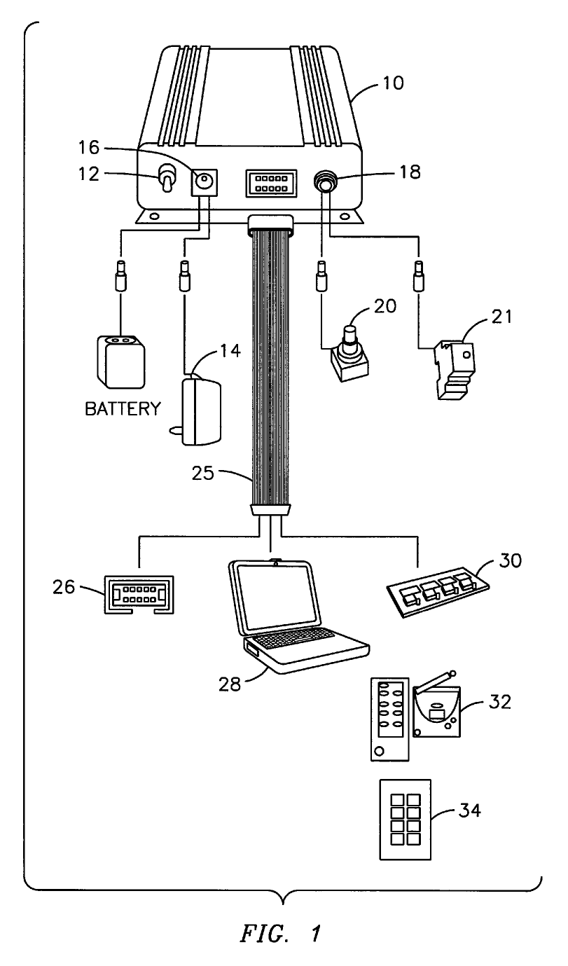

FIG. 1 depicts an exemplary illustration of a front side of a controller with elements that may be connected to the controller. As illustrated the controller 10 may have an on/off switch 12. A power supply 14 is also provided which fits within a receiver element 16 on the controller 10. A remote dimming outlet 18 is also provided. A wall dimmer 20 and/or a dimming relay 21 may be attached to this outlet 18. The dimming relay 21 may allow the controller to be dimmed based on another dimming control (not shown).

A remote control select cable 25 is also provided. This cable 25 may connect the controller 10 to a plurality of control devices. For example, a manual program control device 26 may be provided. A custom program control device 28 may be used. As illustrated an exemplary program control device 28 may be facilitated through a computer. A remote program control panel or device 30 is also possible. Additionally, a remote control unit 32 and/or a wall switch control device 34 may also be provided.

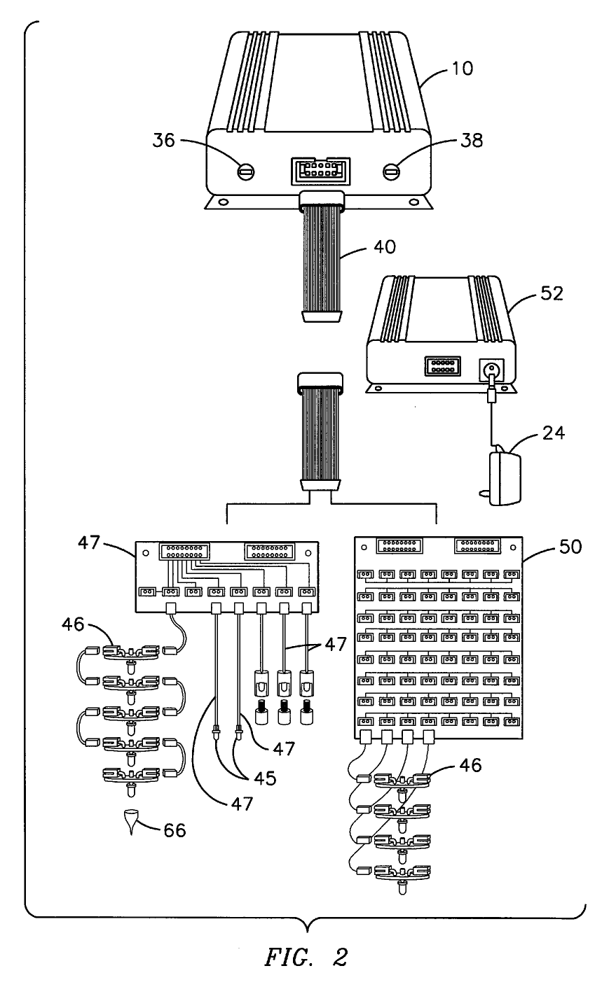

FIG. 2 depicts an exemplary illustration of a back side of the controller with elements that may be attached to the controller. As illustrated a manual dimming control 36 may be available. Also a speed control 38 is available. The speed control 38 may control the rate at which the lights blink, or turn from off to on. Though illustrated as being manually controlled, both may be remotely controlled as well.

As further illustrated, a communication cable 40 provides a signal to a LED 45. The communication cable 40 may have a plurality of cables. A distribution panel 47 is provided so that a single controller 10 may provide lighting signals to a plurality of LEDs 45, 46, 47. A special effects distribution panel 50 may also be provided where it again may provide lighting signals to a plurality of LEDs 47. As illustrated the LEDs attached to the special effects distribution panel 50 are various colored LEDs, such as but not limited to blue, green, orange, yellow, white, and red. To insure a strong enough signal, a multiplier 52 may be provided between the controller 10 and the panel(s) 40, 50 to boost the lighting signals. The multiplier 52 has a power cord 24. Therefore, in operation, a signal controller 10 may be used to light a plurality of LEDs up to a certain amount, such as 100 where each LED is connected to the controller 10 through the distribution panel 40, 50. When additional LEDs are to be lit, the multiplier 52 is included in the system.

FIG. 3 depicts an exemplary illustration of a distribution panel with LEDs attached. The connection lead 60 between the LED that interfaces with the distribution panel 40 has a release mechanism 62 to allow for easy removal of the LED 45, 47 from the distribution panel 40. Such a mechanism may include, but is not limited to phone connection junction devices and/or Ethernet connectors. If a failure occurs with a LED 45, 47, a user would simply have to disconnect the LED lead 60 from the distribution panel 40 as oppose to severing the connection to the controller 10.

As further illustrated, some LEDs 45 may have caps 66, such as but not limited to color caps and water tight caps which may be color, that fits over the LED 45. Other LEDs 47 may have a device 68 holding fiber optic strands 70 proximate a respective the LED 47 so that fiber optic strands 70 may illuminate light from the respective LED 47 to an end of the fiber optic strands 72.

The ends 72 of the fiber optic strands are usually passed through a panel, such as a ceiling panel. When used with other features though, such as lamps, picture frames, etc., the strands 70 and/or caps 66 may be fixed to parts of these devices. Regarding placement in a panel, the caps 66 are usually fixed into place within the panel.

The caps 66 are usually configured with a diameter greater than the LED. The diameter of the cap 66 usually does not decrease along the length of the cap 66. The fiber optic strands 70 however, when placed in proximity to the respective LED 47 result in light emitters that are of a smaller diameter than the LED 47. Therefore when a light emitter smaller than a diameter of an LED is required, such as when providing star lighting, fiber optic strands 70 are the preferred lighting option.

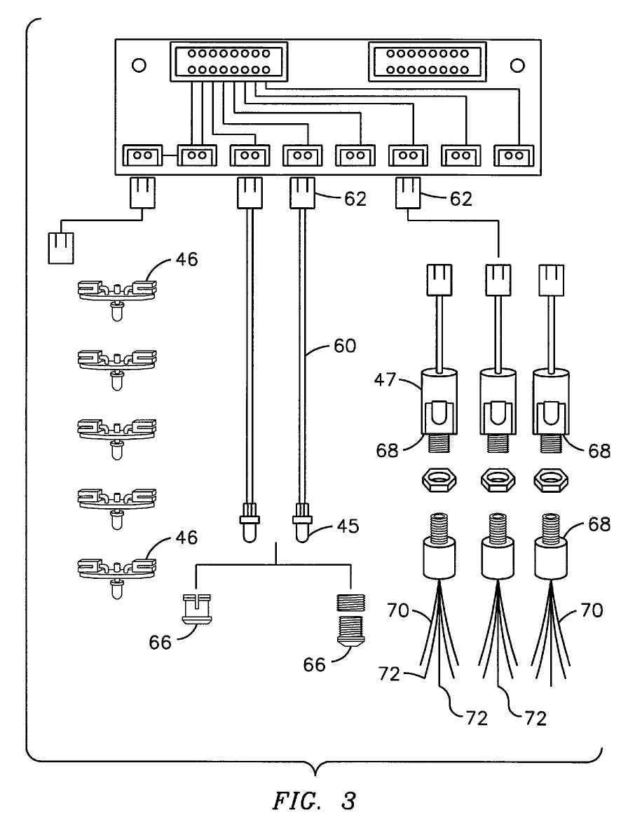

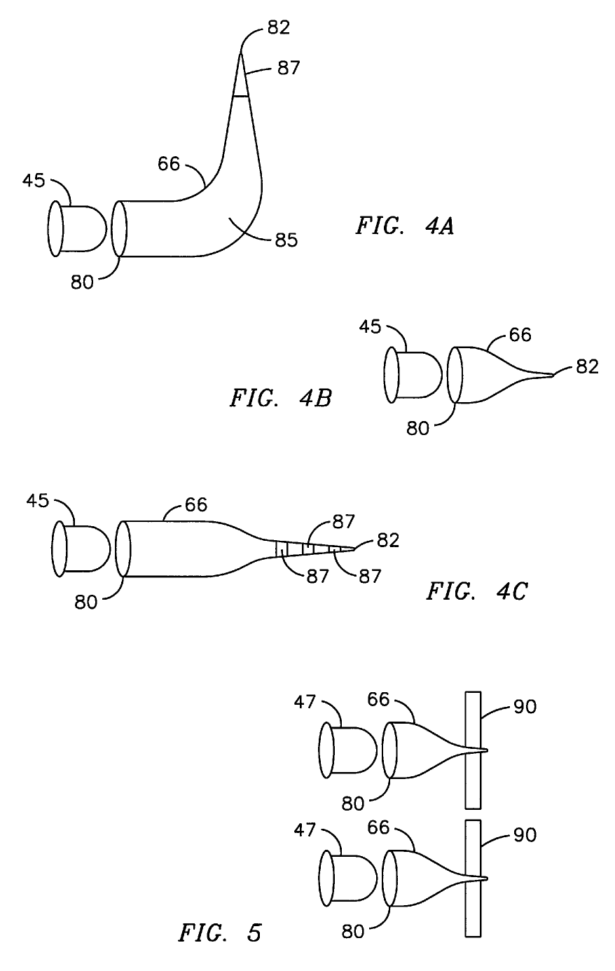

FIG. 4 depicts a plurality of hardened light emitters that may provide light through a smaller diameter than the diameter of the LED. As illustrated though the base end 80 of the lens 66 is of a diameter to encompass the LED 45, the light emitting end 82 is of a smaller diameter. The light emitting end 82 may be as small as a diameter of a fiber optic strand 70, or smaller.

This cap 66 is made of a hardened material such as but not limited to plastic. The area of the cap 66 from the LED 45 to the end of the lens may have a coating, such as paint 85 so that light may not emit but at the far end of the lens, as illustrated in FIG. 4A. By doing so, all light is emitted from the far end, or end of the cap. In another embodiment, several areas on the cap may not be coated so that light is emitted from selected parts 87 of the cap 66, as illustrated in FIG. 4C. In another embodiment, none of the lens is coated, as illustrated in FIG. 4B. As further illustrated in FIG. 4A, embodiments of this cap 66 may have a plurality of shapes. Thus the light can be bent to contour to a area through which the cap 66 must be fitted.

FIG. 5 depicts an illustration of caps fixed within a panel. Because the cap 66 is hardened, though it may be secured in place with an epoxy, which is typical for fiber strands 70, it may also be pressed into position through a panel 90. Therefore if required, the cap 66 may be removed from its place of operation by pulling it in an opposition direction that it was pressed into position into the panel 90. Therefore, when used in an application where the application may experience wear and tear, such as but not limited to in a lamp, a display panel that is shown at various trade shows, or an ornamental display within a residence, etc., the longevity of the cap 66 is more likely to exceed those of a flimsy fiber optic strand 70.

While the invention has been described in what is presently considered to be a preferred embodiment, many variations and modifications will become apparent to those skilled in the art. Accordingly, it is intended that the invention not be limited to the specific illustrative embodiment, but be interpreted within the full spirit and scope of the appended claims.

What is claimed is:

1. A modular light system, the system comprising:
a distribution panel;
a light emitter connected to an output end of the distribution panel;
a controller connected to an input end of the distribution panel;
a power source connected to said controller;
a harden cap configured to fit around an illumination part of the light emitter at a first end and emits light from a second end that is decreased in diameter when compared to the first end.

2. The system according to claim 1 wherein the controller at least one of provides power to said light emitter and regulates illumination intensity and illumination duration of said light emitter.

3. The system according to claim 1 wherein the harden cap extends in a single direction from the light emitter.

4. The system according to claim 1 wherein the harden cap changes direction that it extends from the light emitter.

5. The system according to claim 1 further comprises a covering over part of the harden cap to prevent emission of light from the covered area.

6. The system according to claim 5 wherein an area for light to emit from the cap is at an end of the cap distant from the light emitter.

7. The system according to claim 5 wherein a plurality of areas are provided for light to emit from the cap.

8. The system according to claim 1 wherein the distribution panel is configured to illuminate a plurality of light emitters using a single controller.

9. The system according to claim 1 further comprises a multiplier connected between the distribution panel and the controller.

10. The system according to claim 9 wherein the multiplier increases a signal from the controller when a given number of emitters connected to the controller is exceeded.

11. The system according to claim 1 wherein the distribution panel comprises a special effect distribution panel.

12. The system according to claim 1 further comprises a cable for connecting the controller to the distribution panel, a cable for connecting the light emitter to the distribution panel wherein ends of a respective cable comprises a connection device allowing the connector to be removable form the respective component it is connected into.

13. The system according to claim 12 wherein connection is severed by activating a release mechanism connected to the connection device.

14. A light emitter lens for use within a light emitting system, configured to experience high impact environments, the lens comprises a harden lens with a diameter proximate a size of a light emitter at a first end and a diameter significantly smaller at a second end.

15. The lens according to claim 14 further comprises a covering on areas of the lens to prevent emission of light at areas where the covering is provided.

16. The lens according to claim 14 wherein the covering is provided on the lens so that light is only emitted from the second end of the lens.

17. The lens according to claim 14 wherein the second end of the lens is of a diameter as small as a diameter of a fiber optic strand.

18. A distribution panel system for having a plurality of light emitters operated by a single controller, the system comprising:
a distribution panel configured to receive a signal from a controller and distribute the signal to a plurality of light emitters; and
a releaseable connector attached to each cable the attaches to the distribution panel so that each device may be removed should a failure is determined to be caused by a respective device.

19. The distribution panel system according to claim 18 wherein the distribution panel is configured to produce special effects.

20. The distribution panel system according to claim 18 further comprises a multiplier that connects between the distribution panel and the controller when a specific number of light emitters is exceeded connected to the distribution panel.
